(19) United States
(12) Patent Application Publication
(10) Pub. No.: US 2026/0023578 A1
(43) Pub. Date: Jan. 22, 2026

(54) PARALLEL ARTIFICIAL INTELLIGENCE DRIVEN IDENTITY CHECKING WITH DYNAMIC PROMPTING

(71) Applicant: The Toronto-Dominion Bank, Toronto (CA)

(72) Inventors: Emily Anne Lowther, Elmira (CA); Claire Iona Wilcox, Toronto (CA); Susan Marjorie Juvet, Toronto (CA); Jeffrey M. Grace, Delaware (CA); Shuyun Huang, Toronto (CA)

(73) Assignee: The Toronto-Dominion Bank, Toronto, ON (CA)

(21) Appl. No.: 18/777,930

(22) Filed: Jul. 19, 2024

(51) Int. Cl. G06F 9/451; G06F 3/0484

(52) U.S. Cl. CPC G06F 9/451; G06F 3/0484

(57) ABSTRACT

An example operation may include one or more of receiving input data via at least one data prompt via an input field on a computing device, receiving device data from the computing device, executing a trained artificial intelligence (AI) model to determine at least one data validation step based on the input data and the device data, identifying that at least one additional data prompt is needed to collect additional input data to execute the at least one data validation step, creating the at least one additional data prompt, augmenting the input field on the computing device with the at least one additional data prompt, receiving the additional input data via the input field based on the at least one additional data prompt on the computing device, and executing the at least one data validation step based on the received additional input data.

### BACKGROUND

Online application forms (applications) are used by users to sign up for products and services. For example, an application form may be accessed by visiting a publicly available website or through a mobile device software application that can be downloaded and installed from a digital distribution platform. The application form may include fields, boxes, drop-down menus, upload sections, and other graphical elements that a user can manipulate through a user interface thereby adding content to the application form. Accordingly, the user may enter personal information, educational history, work history, skills, qualifications, provide answers to questions, and the like. The user may then select a button or other graphical element within the application form to submit the application form to a host server for further processing.

### SUMMARY

One example embodiment provides an apparatus that includes a memory communicably coupled to a processor, wherein the processor may one or more of receive input data via at least one data prompt via an input field on a computing device, receive device data from the computing device, execute a trained artificial intelligence (AI) model to determine at least one data validation step based on the input data and the device data, identify that at least one additional data prompt is needed to collect additional input data to execute the at least one data validation step, create the at least one additional data prompt, augment the input field on the computing device with the at least one additional data prompt, receive the additional input data via the input field based on the at least one additional data prompt on the computing device, and execute the at least one data validation step based on the received additional input data.

Another example embodiment provides a method that includes one or more of receiving input data via at least one data prompt via an input field on a computing device, receiving device data from the computing device, executing a trained artificial intelligence (AI) model to determine at least one data validation step based on the input data and the device data, identifying that at least one additional data prompt is needed to collect additional input data to execute the at least one data validation step, creating the at least one additional data prompt, augmenting the input field on the computing device with the at least one additional data prompt, receiving the additional input data via the input field based on the at least one additional data prompt on the computing device, and executing the at least one data validation step based on the received additional input data.

A further example embodiment provides a computer readable storage medium comprising instructions, that when read by a processor, cause the processor to perform one or more of receiving input data via at least one data prompt via an input field on a computing device, receiving device data from the computing device, executing a trained artificial intelligence (AI) model to determine at least one data validation step based on the input data and the device data, identifying that at least one additional data prompt is needed to collect additional input data to execute the at least one data validation step, creating the at least one additional data prompt, augmenting the input field on the computing device with the at least one additional data prompt, receiving the additional input data via the input field based on the at least one additional data prompt on the computing device, and executing the at least one data validation step based on the received additional input data.

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3A is a system diagram illustrating an operating environment for a product application service that identifies and creates at least one additional prompt to collect additional application data when processing at least one needed identity check for a product application form, according to examples and features of the instant solution.

FIG. 3B is a diagram illustrating a method for augmenting the product application form with at least one additional data prompt to collect additional application data, according to examples and features of the instant solution.

FIG. 4A is a flow diagram illustrating a method for a product application service that identifies and creates at least one additional prompt to collect additional application data when processing at least one needed identity check for a product application form, according to examples and features of the instant solution.

FIG. 4B is another flow diagram illustrating a method for a product application service that identifies and creates at least one additional prompt to collect additional application data when processing at least one needed identity check for a product application form, according to examples and features of the instant solution.

FIG. 5 is a system diagram illustrating a computing environment according to the instant solution's example features, structures, or characteristics.

### DETAILED DESCRIPTION

It is to be understood that although this disclosure includes a detailed description of cloud computing, implementation of the instant solution recited herein is not limited to a cloud computing environment. Rather, the instant solution is capable of being implemented in conjunction with any other type of computing environment now known or later developed.

During a typical online application process, a user inputs content into forms, fields, etc., of the application. Meanwhile, security checks are not performed on the filled-in content until the application is completed and submitted in its entirety to a host server. The benefit of this process is that the security checks are performed on a completed application. However, by waiting to perform the security checks until the application is completed, the host server is unable to identify security concerns which may be corrected or addressed before the application is submitted. Moreover, when a security concern, such as an issue with an identity check, is detected during subsequent processing of the application, the application is typically halted/suspended from further processing until a person from the organization can review the application and communicate with the applicant to obtain more information.

The examples and features of the instant solution are directed to a host platform that can automate one or more security checks on a partially completed application form that is currently being filled in by a user. For example, the host platform may detect a security concern based on content within the partially completed application and automatically starts processing one or more security checks (e.g., identity verification, background checks, credit checks, etc.) on content entered into the application before the user has completed the application. Furthermore, rather than prevent the user from completing the application (i.e., suspending the application process), the host platform may dynamically augment the application form with additional data prompts, allowing the user to continue to fill in the application without the user being aware that the application form is being augmented with additional data prompts to collect additional application data that is needed for the identity checks.

The application may include checkpoints therein which are used by the host platform to verify the content within the application form up to the checkpoint. For example, the application form may include multiple pages. After each page there may be a checkpoint that causes the host platform to run a check on the data entered by the user. The host platform may perform a screen capture of the content that has been entered into the partially completed application and compare the content from the partially completed application form to verification data that is held by the host platform and/or accessed from one or more external data sources and the like, such as publicly available data sources. Application data may also be referred to as input data, application form may also be referred to as input field, and needed identity check may also be referred to as data validation step.

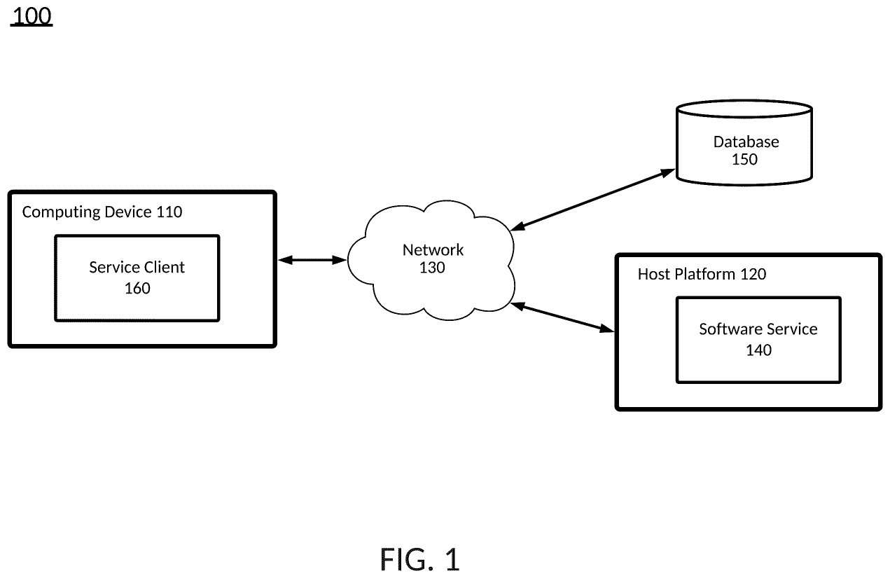

FIG. 1 is a system diagram illustrating an example operating environment of the instant solution. As shown, one or more computing devices 110, and a host platform 120 communicate via a network 130. The host platform 120 may host a software service 140. The software service 140 may communicate with one or more databases 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network, or the like.

The software service 140 provides the service logic. It may provide one or more Application Programming Interfaces (APIs) for communicating with one or more service clients 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The one or more service clients 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the product application service in the instant solution are further described and depicted herein.

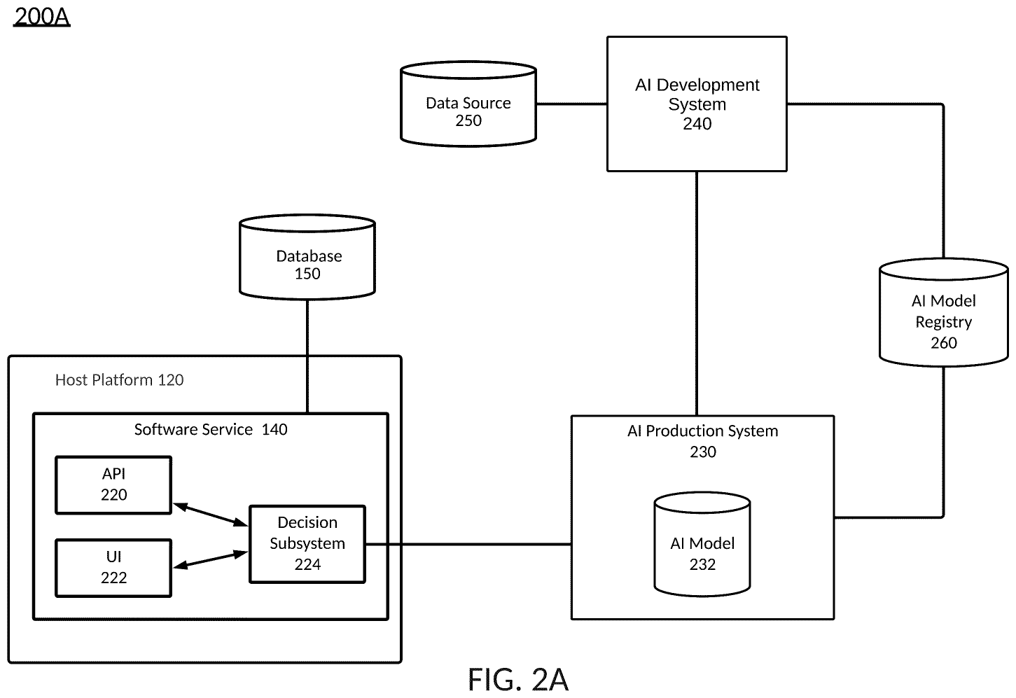

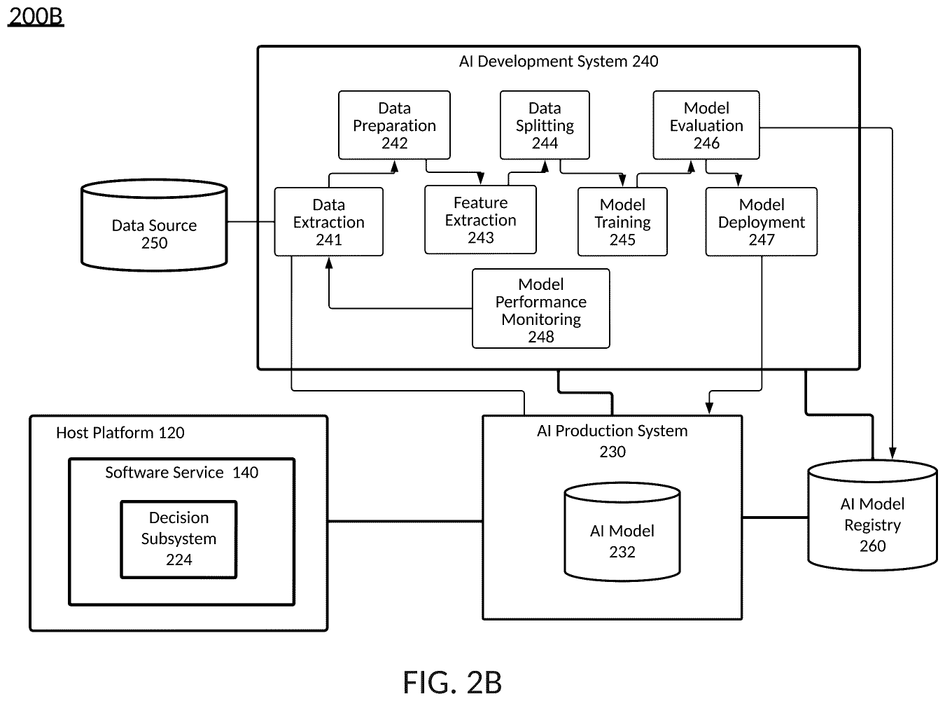

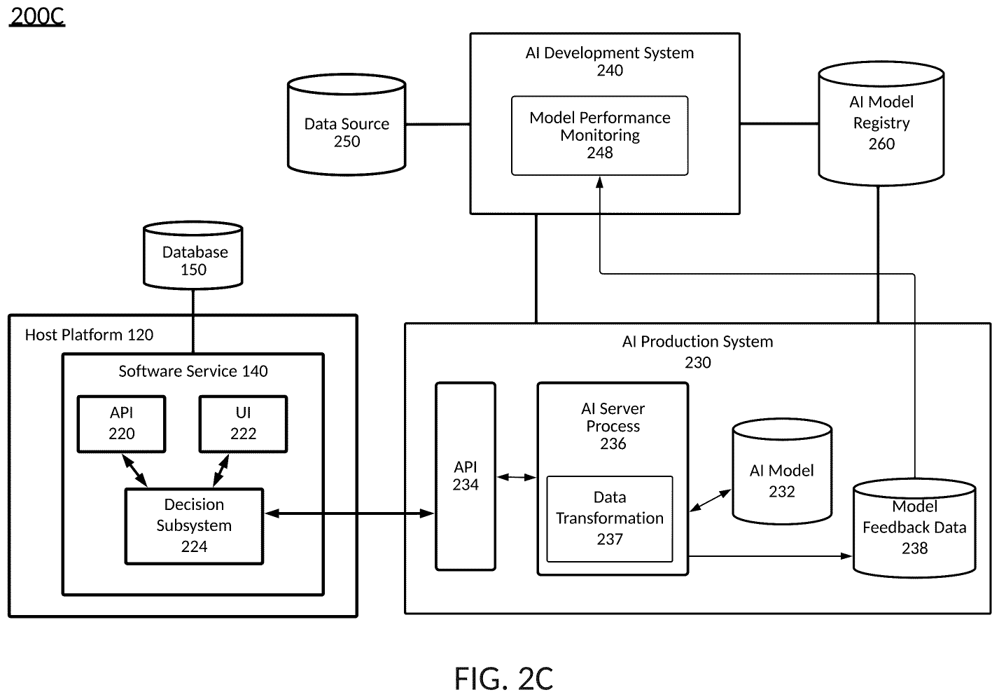

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 140 to assist in decision-making. In some examples and features of the instant solution, the software service 140 stores data included in API requests or data generated during processing the API requests into one or more databases 150 (see FIGS. 1, 2A).

Software service 140 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 140 to assist with decision-making. In some examples and features of the instant solution, the software service 140 stores data included in UI requests or data generated during processing the UI requests into one or more databases 150.

Software service 140 may include one or more decision subsystems 224 that drive a decision-making process of the software service 140. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes execution feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

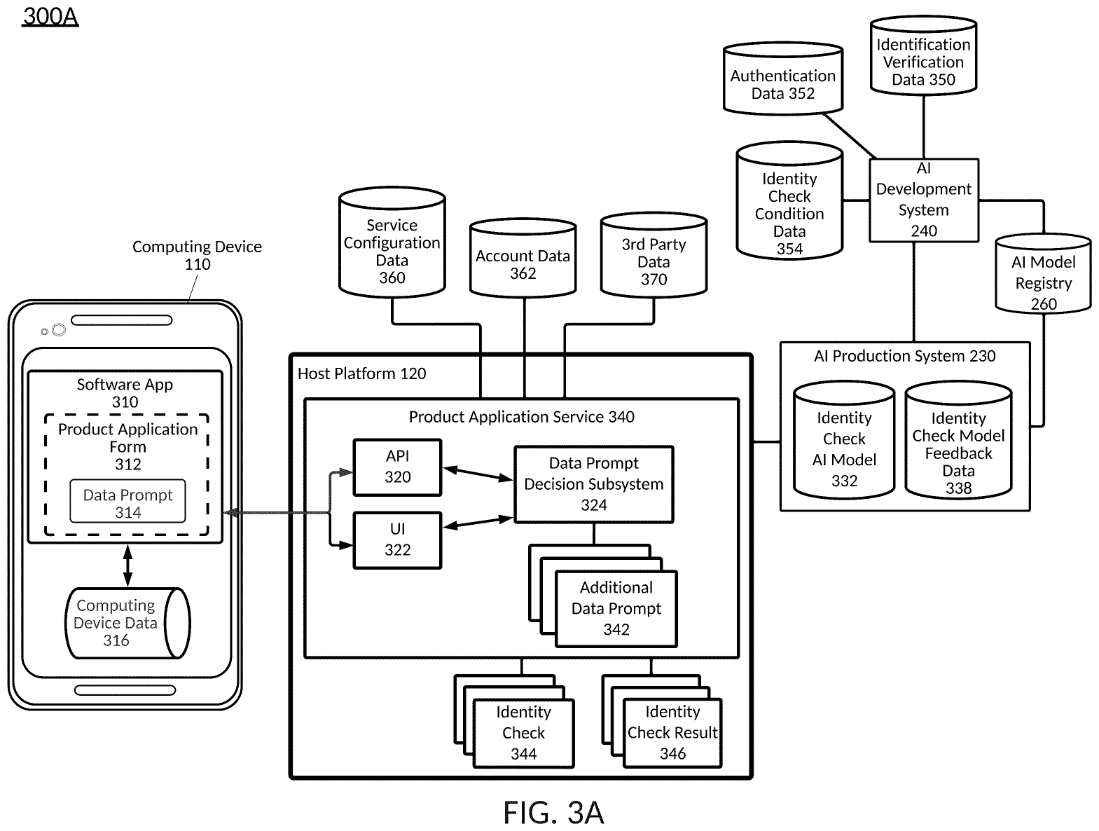

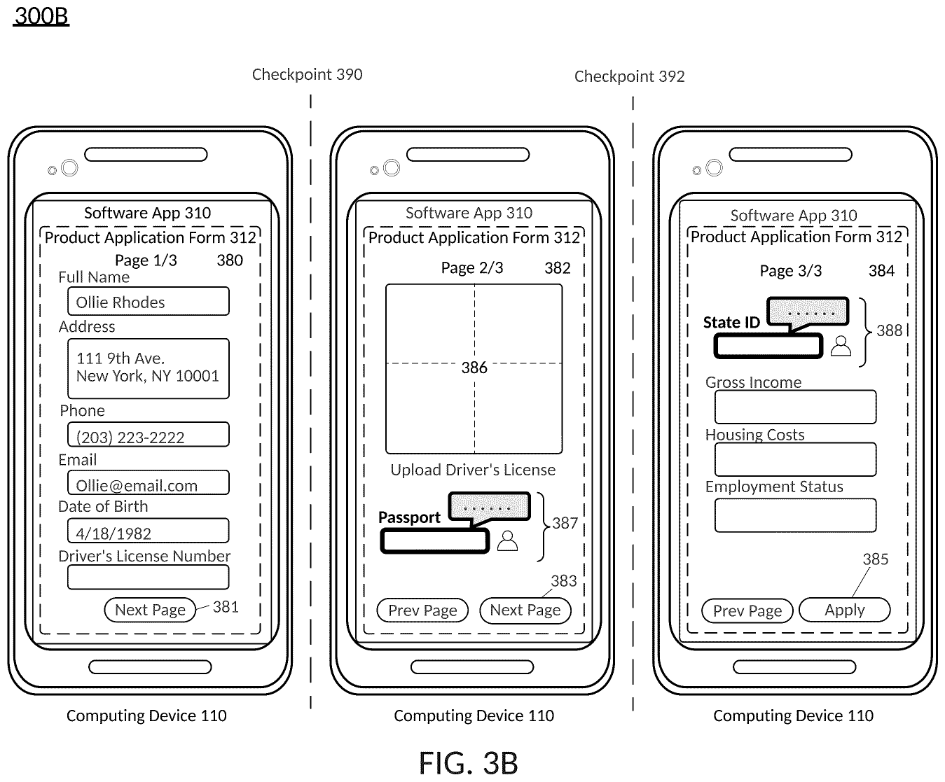

FIG. 3A is a system diagram illustrating an operating environment 300A for an operating environment for a product application service that identifies and creates at least one additional prompt to collect additional application data when processing at least one needed identity check for a product application form, according to examples and features of the instant solution. In operating environment 300A, an AI model is trained to determine at least one needed identity check given applicant data from a product application form and device data from a computing device.

In some examples and features of the instant solution, an identity check AI model 332 is trained using identity verification data 350, authentication data 352 (such as historical customer authentication data), identity check condition data 354, and identity check model feedback data 338 to determine needed identity checks, given a set of feature data transformed from a set of product application data and computing device data. The identity check AI model 332 is an example of AI model 232 (see, for example, FIGS. 2A-2C). The identity verification data 350, the authentication data 352, and the identity check condition data 354 are examples of data source 250 (see, for example, FIGS. 2A-2C). The identity check model feedback data 338 is an example of model feedback data 238 (sec, for example, FIG. 2C), and identity check model feedback record is an example of model feedback record.

In some examples and features of the instant solution, the identity check AI model 332 is trained using a neural network training method and/or capability, such as, but not limited to, gradient descent, stochastic gradient descent, random search, uniform search, basin hopping, or Krylov. In some examples and features of the instant solution, the identity risk AI model 332 is a single or multi-layer perceptron neural network, a feed-forward neural network, a radial basis functional neural network, a recurrent neural network, or a modular neural network.

In some examples and features of the instant solution, the identity check AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data may include, but is not limited to, at least one of identity verification data, authentication data, customer authentication data, historical customer authentication data, identity check condition data, current financial record data, historical financial transaction data, model feedback data, and the like. In some examples and features of the instant solution, the training data for the identity risk AI model 332 may include, but is not limited to, internal data sources, external data sources, private data sources, public data sources, account data, third party data, configuration data, range data, or the like.

In some examples and features of the instant solution, the identity verification data may include but is not limited to governmental identification numbers, driver's license numbers, physical mailing addresses, property purchase records, and credit scores. The historical customer authentication data may include, but is not limited to, user identifiers, email addresses, media access control (MAC) addresses of the one or more computing devices 110 and previously used authentication source internet protocol (IP) addresses of the one or more computing devices 110. The identity check condition data may include, but is not limited to, combinations of identity data for different types of product applications (such as for car loans, for home mortgages, for credit cards, etc.), identity risk levels, conditions for approval, conditions for rejection, other condition criteria, along with weights and thresholds. In some examples and features of the instant solution, the identity check AI model may be trained and developed as a single AI model. In some examples and features of the instant solution, the identity check AI model may be trained and developed as a multi-stage model that includes a first AI model trained on identity verification data and authentication data to predict identity risk levels and a second AI model trained on identity risk levels to determine identity checks to be performed. The model feedback records in the identity check model feedback data 338 may include, but is not limited to, a determined identity check, an identified additional data prompt, a received application data or device data, a final product application identity check result (e.g. pass/fail), and an AI model request identifier. In some examples and features of the instant solution, the determined identity check may include, but not limited to, a function within the product application service 340, a query to an account data source 362, a query to a third-party data source 370, or the like. Once the identity check AI model 332 is trained and validated, it is deployed to an AI production system 230 (see, for example, FIGS. 2A-2C, 3A) for use by a product application service 340. The product application service 340 is an example of software service 140 (see, for example, FIG. 1, 2A-2C).

In some examples and features of the instant solution, during an online product application process, an applicant logs into a service client 160 (see FIG. 1) associated with a service provider offering a product. The software app 310, running on computing device 110, is an example of service client 160 (see FIG. 1). In some examples and features of the instant solution, when requesting a product, an applicant is presented with a product application form 312. The product application form 312 may include fields grouped based on the type of data being requested such as identification data, employment history, income, etc. As the applicant inputs data into the fields on the product application form 312, the data is collected and may be sent to the product application service 340. In some examples and features of the instant solution, the application data is streamed to the product application service 340 as it is input. In some examples and features of the instant solution, the application data is checkpointed into the groups of related product application form 312 data. In some examples and features of the instant solution, the application data is checkpointed for each page, section, or other area of the product application form 312.

In some examples and features of the instant solution, the product application service 340 receives product application data from the product application form 312. The application data may include but is not limited to the applicant's name, governmental identification number, driver's license number, current employment information, and financial account information. Additionally, the product application service 340 receives data about the computing device 110 which is being used by the applicant. The device data 316 may include, but is not limited to, the MAC address and the source IP address of the computing device. In some examples and features of the instant solution, the product application service 340 retrieves and formats the received application data and device data into feature sets that the AI model can interpret. When the product application service 340 receives application data and/or device data, the product application service 340 initiates an identity check request to the identity check AI model 332 resident on the AI production system 230 (see, for example, FIGS. 2A-2C, 3A), supplying the set of required data. In some examples and features of the instant solution, the product application service 340 may continue to receive and process data from the product application form 312 in parallel in determination of the identity check or other identity checks.

In some examples and features of the instant solution, upon receiving the request, the AI production system 230 (see FIGS. 2A-2C, 3A), transforms 237 (see FIG. 2C) the set of required data into a set of valid feature values in the identity check AI model 332. The identity check AI model 332 is then executed with the transformed data, the result of which is at least one needed identity check. In some examples and features of the instant solution, the at least one identity check is returned in a response to the product application service 340. In some examples and features of the instant solution, the response includes a request identifier that can be used by the product application service 340 to provide feedback on the performance of the identity check AI model 332.

In some examples and features of the instant solution, upon receiving the response from the identity check AI model 332, the product application service 340 determines the at least one identity check 344 from the identity check AI model 332 may be executed with the received application data from the at least one data prompt 314 on the product application form 312 and/or the received device data 316 from the computing device 110.

In some examples and features of the instant solution, upon receiving the response from the identity check AI model 332, the product application service 340 determines the at least one identity check 344 from the identity check AI model 332 may not be executed yet, and the product application service 340 requests the data prompt decision subsystem 324 to identify at least one additional data prompt 342 to collect additional application data needed to execute the at least one needed identity check 344. The data prompt decision subsystem 324 compares the received application data from the at least one data prompt 314 of the product application form 312 and the inputs for the at least one identity check 344. From this comparison, the data prompt decision subsystem 324 identifies and creates at least one additional prompt 342 and then invokes API 320 or UI 322 to augment the product application form 312 with the at least one additional prompt 342. Depending on the type of service client on the computing device 110, the API 320 or the UI 322 is utilized. When the installed software app 310 is a thick service client associated with the product application service 340, the product application service 340 and the data prompt decision subsystem 324 may control the graphical elements on the product application form 312 by invoking methods defined by the API 320. When the software app 310 is a browser-based service client, the product application service 340 and the data prompt decision subsystem 324 may invoke methods defined by the browser-based UI 322 to generate the graphical elements of the product application form 312. Meanwhile, the product application service 340 may continue to receive and process application data from the product application form 312.

In some examples and features of the instant solution, the data prompt decision subsystem 324 utilizes a set of rules defined in service configuration data 360 to identify the at least one additional data prompt 342. The service configuration data 360 is an example of database 150 depicted in FIG. 1. In some examples and features of the instant solution, rules are based on the inputs for the identity check 344. In some examples and features of the instant solution, rules are based on a set of application form data. In some examples and features of the instant solution, service configuration data 360 may include, but not limited to, rules, statically defined data prompts prior to runtime execution, combinations of statically defined data prompts with dynamic substitutions that are updated during runtime execution, and the like.

In some examples and features of the instant solution, in response to receiving the additional application data based on the at least one additional data prompt 342, the product application service 340 may execute the at least one needed identity check 344. The at least one identity check 344 may involve cross-referencing the received data against external databases (public or private), checking validity against third-party services, or internally validating details such as credit history and governmental ID numbers. This parallel handling is managed by multitasking capabilities of the processor, ensuring that data reception and processing do not stall the identity verification steps.

In some examples and features of the instant solution, the at least one identity check 344 is initiated when the product application service 340 has the received data and/or collected data for the inputs of the identity check 344. In some examples and features of the instant solution, the identity check 344 utilizes service provider account data 362 to validate the applicant's identity. This account data may be associated with the applicant, or persons related to the applicant (such as a person associated with the applicant on a joint account). In some examples and features of the instant solution, the identity check 344 utilizes third-party data 370 that may include, but is not limited to, identity data, property records, financial account data and credit reporting data.

In some examples and features of the instant solution, the product application form 312 is updated upon receipt of the next checkpoint of application data. In some examples and features of the instant solution, the product application form 312 is updated when the final result of the at least one identity checks 344 is determined. In some examples and features of the instant solution, the product application form 312 is updated and augmented when the API 320 or UI 322 is invoked with additional data prompts to collect additional data.

In some examples and features of the instant solution, all of the at least one identity check 344 must be successful for the final result to be considered successful. In some examples and features of the instant solution, an identity check 344 is considered incomplete when a technical issue prevents its timely completion and an incomplete identity check results in a failed final result. In some examples and features of the instant solution, an incomplete identity check 344 does not impact the final result when a minimum number of the at least one identity check 344 completes successfully.

In some examples and features of the instant solution, an identity check 344 is considered incomplete when additional needed application data has not been collected yet for the identity check. In some examples and features of the instant solution, an identity check 344 is considered incomplete when the additional needed application data is collected, however, the identity check is still unable to conclusively verify the applicant's identity. While the identity check is considered incomplete, the data prompt decision subsystem 324 dynamically determines whether to identify and create another additional data prompt. This determination may be based on a maximum threshold of additional data prompts for the given identity check, which may be configured and accessed in the service configuration data 360. This determination may also be based on the number of acceptable forms of identification that are allowable for the applicant's city, municipality, county, township, state, country, etc., such as a state-issued ID, a state-issued driver's license, a county-issued voter registration ID, a country-issued passport, or the like. When the data prompt decision subsystem 324 determines it cannot proceed further with the identity check 344, a result for the incomplete identity check is included with the other identity check results 346.

In some examples and features of the instant solution, upon receiving the at least one needed identity check from the identity check AI model 332, the product application service 340 initiates the data prompt decision subsystem 324 to determine whether the received application data includes the data for the needed identity check 344. The data prompt decision subsystem 324 initiates a data input comparison, comparing the received application data against the inputs for the needed identity check. The comparison may include determining the received application data types and comparing them against the expected inputs for the needed identity check. The results of the data input comparison may conclude that the received application data is lacking at least one data that is needed for the identity check. For example, the received application data may reveal that the applicant does not possess specific forms of identification, such as a driver's license number because the applicant does not drive. Without valid forms of identification, the identity check 344 cannot be executed unless additional identification is collected. Based on the data input comparison, the data prompt decision subsystem 324 performs data prompt identification to identify the types of additional application data to be collected and to identify a corresponding additional data prompt 342 that is applicable for the additional application data to be collected. For example, a set of valid identification types along with corresponding data prompts may be stored and accessed in service configuration data 360, configured statically before runtime execution or dynamically provisioned, updated, or determined during runtime execution.

When at least one additional data prompt 342 is identified and is created, the data prompt decision subsystem 324 invokes API 320 or UI 322 to augment the product application form 312 with the at least one additional data prompt 342. Depending on the type of service client on the computing device, API 320 or UI 322 is utilized. The API and the UI may define functions for the data prompt decision subsystem 324 to display graphical clements on the product application form 312, such as text fields, radio buttons, checkboxes, dropdown lists, buttons, help tips, scrollbars, pop-up dialogs, modals, progress bars, links, buttons, and the like, to display the additional data prompt 342 and to intake additional application data for further processing. In some examples and features of the instant solution, the additional data prompt 342 may include a link, a button, or a verbal prompt for the applicant to contact an entity for assistance, such as a contact center agent, an operator, or an AI assistant/chatbot.

In some examples and features of the instant solution, the graphical elements of the product application form 312 are statically defined and served to the software app 310. In some examples and features of the instant solution, the graphical elements of the product application form 312 are dynamically generated. In some examples and features of the instant solution, the graphical elements of the product application form 312 may comprise a combination of statically defined and dynamically generated graphical elements, where the dynamically generated graphical elements may augment statically defined areas of the product application form 312.

In some examples and features of the instant solution, the data prompt decision subsystem 324 may include a verbal prompt along with the additional data prompt 342 on the product application form 312, providing a communication option for the applicant to verbally utter a predefined prompt comprised of a sequence of reserved words which can be detected by the computing device's audio sensors, such as a microphone. The verbal prompt is displayed and enabled on the product application form 312 when the computing device 110 allows the software app 310 to utilize the microphone. When the software app 310 detects the verbal prompt, the verbal prompt feature is triggered, and the product application service 340 initiates contact with an entity for assistance. For example, the product application service 340 may initiate a communication session that connects the requested entity with the applicant, where the communication session may be a textual chat session, an audio call, or a video call, and where the requested entity may be a contact center agent, an operator, or an AI assistant/chatbot. In some examples and features of the instant solution, the AI assistant/chatbot may utilize one or more additional AI models, such as an AI model (not shown) deployed to the AI production system 230 (see, for example, FIGS. 2A-2C, 3A) or deployed to another AI production system (not shown) and trained to assist with the prompts and data presented on the product application form. The AI assistant/chatbot may be visually represented as an avatar on the user interface of the product application form 312 or the software app 310 and may be configured to accept verbal input or typed input from the applicant and to reply with audible output or text output.

In some examples and features of the instant solution, the additional data prompt 342 may display predefined text in combination with variable text that may be substituted in real-time or near real-time to provide a more descriptive prompt for collecting the additional application data. For example, the applicant did not provide any driver's license information in the previously received application data because the applicant does not drive. In identifying an appropriate data prompt, the data prompt decision subsystem 324 determines that in the applicant's state of residence, another valid form of identification is a state-issued identification card, and the data prompt decision subsystem 324 identifies an appropriate prompt, using predefined text in combination with variable text which can be substituted in real-time or near real-time to provide a more descriptive data prompt. For example, the prompt created by the data prompt decision subsystem 324 may state, “If you do not possess a New York state driver's license, please enter your New York state-issued identification card ID number, which can be found in the upper righthand corner”. The underlined text is for demonstration purposes and indicates the dynamically inserted variable text. In this example, the data prompt decision subsystem 324 dynamically substitutes the name of the state where the applicant resides, as the applicant's residential address was previously provided with the received application data. Also, the data prompt decision subsystem 324 dynamically determined that only the ID number field is to be collected, as the applicant's name, birthdate, residence, etc. had already been received. In addition, a hint is included in the additional data prompt 342 to assist the applicant in finding the ID number on their state-issued identification card, further ensuring the additional application data is supplied.

In some examples and features of the instant solution, predefined static text for the additional data prompts may be configured prior to runtime execution of the instant solution and stored locally in the processor's communicatively coupled memory or stored in service configuration data 360, which may be a private databased co-located or distributed remotely on a network.

In some examples and features of the instant solution, the text for additional data prompts may be dynamically provisioned and updated during runtime execution of the instant solution and stored locally in the processor's communicatively coupled memory or stored in service configuration data 360, which may be a private database co-located or distributed remotely on the network.

In some examples and features of the instant solution, the data prompt decision subsystem 324 may utilize one or more additional AI models, such as an AI model (not shown) trained on additional data prompts, application form data, and identity checks, to dynamically generate data prompts to collect additional data. The one or more additional AI models may be deployed to the AI production system 230 (see, for example, FIGS. 2A-2C, 3A) or to another AI production system (not shown) and may be utilized by the data prompt decision subsystem 324.

In some examples and features of the instant solution, the product application service 340 and the data prompt decision subsystem 324 may continue to receive and process application form data from the product application form 312 in parallel while processing data input comparison, data prompt identification, identity checks, and the like.

In some examples and features of the instant solution, the product application service 340 and the data prompt decision subsystem 324 may invoke API 320 or UI 322 to display the additional data prompt 342 while awaiting or receiving additional application data from the product application form 312 or when the application data has been received.

In some examples and features of the instant solution, the execution of the at least one needed identity check 344 may trigger at least one identity check result 346. The identity check result 346 may be included in a model feedback record and incorporated into the model feedback data for further training of the identity check AI model 332. Regardless of the identity check result 346 being a successful result or failed result, the result is used in the training process to further reinforce or refine the identity check AI model 332.

In some examples and features of the instant solution, it is configured to add a model feedback record to the model feedback data and retrain the AI model with the model feedback data. The model feedback record includes several components that collectively capture the specifics of each instance where the AI model is applied. The identity check represents the model's assessment of the received data and determination of which identity verification checks to be performed. The final application identity check result includes the outcomes of any identity verification checks performed based on the AI model's determination. These detail whether the identity was verified successfully, any discrepancies found during the checks, and other relevant outcomes. The model feedback record may include details about the input data fed into the AI model, including application and device data, providing the analysis context. The model feedback record may detail the specific settings and parameters of the AI model at the time of the execution, such as thresholds used for decision-making, features included in the analysis, and other configuration details. The model feedback record also may include timestamps and other metadata like device identifiers, application versions, and user identifiers. The record may also include any feedback received from the execution. This may be direct feedback on the determination accuracy or indirect feedback inferred from subsequent user actions or additional verifications. By compiling these details into a model feedback record and incorporating them into the model feedback data, the AI model can be continually updated and refined.

FIG. 3B illustrates a process 300B of a method for augmenting the product application form with at least one additional data prompt to collect additional application data, according to examples and features of the instant solution. Referring to FIG. 3B, an example product application form 312 of a software app 310 is shown augmented with additional data prompts to collect additional application data. In the example of FIG. 3B, the product application form is a checking account application form, shown with three separate pages, including a first page 380, a second page 382, and a third page 384. Here, each page includes input fields for receiving at least one of text input, image content, document content, biometric content, and the like. For example, the first page 380 includes text-based input fields for name, address, phone, email, date of birth, and driver's license number. The second page 382 includes an input field for receiving a document, images, etc., such as an image of an identification card, a driver's license, or the like. The second page 382 also includes an augmentation in which an additional data prompt has been inserted to collect passport data. The third page 384 includes additional text-based input fields for content directed at income, housing costs, and employment status, as well as an augmentation in which an additional data prompt has been inserted to collect state ID data.

According to various examples and features of the instant solution, checkpoints may be included within the product application form 312 of the software app 310. They may be detected/triggered when an applicant reaches a particular position within the product application form 312. For example, in FIG. 3B, when the applicant presses the next page button 381 on the first page 380 to navigate to the second page 382 of the product application form 312, a checkpoint 390 is encountered. Here, software, such as the product application service 340 (see, for example, FIG. 3A), may receive a notification from the product application form 312 indicating that the applicant has reached the checkpoint 390. The product application service may instruct the software app 310 to perform a screen capture to capture any text content from the first page 380 that has been entered and send it to the product application service. The captured content may be used to determine one or more identity checks to perform.

In addition, the applicant may also submit an image 386 or otherwise upload a document via the second page 382 of the product application form 312 of the software app 310. Here, the applicant may press the next page button 383 on the second page 382 to navigate to the third page 384 of the product application form 312. In this example, when the applicant presses the next page button 383 to navigate to the third page 384, a second checkpoint 392 is encountered. Here, the product application service may receive a notification from the product application form 312 indicating that the user has reached the second checkpoint 392. The product application form 312 may also send the document/image uploaded to the second page 382 by the applicant to the product application service. The document/image content may be used to determine one or more identity checks to be performed.

Next, the applicant may enter information into the input fields of the third page 384 of the product application form 312 and decide to submit their application form by pressing the apply button 385 or the like. In response, the content from the third page 384 may be provided to the product application service as well as an indicator that the applicant completed the product application form 312.

In the examples and features of the instant solution, the execution of the product application service on the host platform for processing the received application data is performed on the backend in parallel while the applicant is still completing the product application form 312 on the software app 310 of the applicant's computing device 110. Referring to FIG. 3B, while the product application form 312 is still in progress, the product application service continues to perform identity checks and other verification checks in parallel. Even when the identity checks on the applicant have been completed, other verification checks may continue in parallel while the product application form 312 is still being completed by the applicant. The product application service continuously processes the received application data, for example, verifying the received data pertaining to a data prompt from the application form while processing received data for another prompt from the application form, acquiring information from account data sources or external data sources for the identity checks and verification checks, and the like, all performed in parallel. The parallel handling allows the product application service to determine in real-time or near real-time when the received application data is lacking and to identify and create at least one additional data prompt for the product application form 312 to collect additional application data for the needed identity check.

In some examples and features of the instant solution, the augmentation of the product application form 312 comprises inserting the at least one additional data prompt with a corresponding input field to collect the application data. The insertion of the additional data prompt and the corresponding input field may be positioned in real-time or near real-time after the currently active input field to provide a continuous user experience, allowing the applicant to input the requested data without detracting from the flow of the remainder of the product application form.

In some examples and features of the instant solution, the augmentation of the product application form 312 may include disabling the remaining prompts on the application form, such as visually changing the color of the remaining application data prompts to a gray text and preventing the input fields from accepting data until the additional application data associated with the additional data prompt has been collected and the needed identity check has been satisfied. Then the applicant may resume the product application form at the point when the augmentation occurred.

In some examples and features of the instant solution, the augmentation of the product application form 312 may include at least one additional data prompt immediately following a last receipt of the application data from at least one data prompt that is visible on the application form. In some examples and features of the instant solution, the at least one additional data prompt may be dynamically inserted inline on the current page of the application form after a visible data prompt and input field or after a currently active input field and data prompt. In some examples and features of the instant solution, when data prompts already exist on the current page of the application form, the at least one additional data prompt may be dynamically inserted on the next page or after the next checkpoint. For example, the additional data prompt may be related to a previous topic that is different than the data prompts on the current page; therefore, the data prompt decision subsystem dynamically determines that the augmentation of the application form may seamlessly occur on the next page or after the next checkpoint, and it provides an indication in the API or the UI invocation that the additional data prompt is not to be inserted immediately after the current visible data prompt.

In some examples and features of the instant solution, the augmentation of the product application form seamlessly inserts additional data prompts without the applicant being aware. For example, the remaining data prompts are shifted and repositioned to allocate an area for the at least one additional data prompt. If the data prompts are prefixed with sequential numbers, the at least one additional data prompt and the shifted data prompts may be renumbered to seamlessly preserve the sequential numbering without the applicant being aware of the insertion of the additional data prompt.

In some examples and features of the instant solution, the augmentation of the product application form 312 may include at least one additional data prompt responsive to the at least one needed identity check being satisfied. The data response, or the lack of data response, to the at least one additional data prompt may still be insufficient, thus another additional data prompt may be created to collect other data to satisfy the at least one needed identity check. Referring to the example in FIG. 3B, the applicant in this example lives in New York City and does not possess a driver's license, therefore, the applicant does not input any data into the field for the data prompt “Driver's License Number” on the first page 380. When the applicant navigates to the second page 382 by pressing the next page button 381, a checkpoint 390 is triggered and the application data is received by the product application service on the host platform. Upon processing the received application data, the data prompt decision subsystem 324 of the product application service 340 (see, for example, FIG. 3A) identifies that the driver's license number is missing in the received application data. Without at least one valid form of identification, the needed identity check cannot be executed, so the data prompt decision subsystem identifies another form of acceptable identification, such as passport data, and dynamically creates an additional data prompt that is applicable for collecting passport data, invoking the API or the UI to augment the product application form 312 with the at least one created additional data prompt to collect passport data 387. In this example of FIG. 3B, the applicant does not possess a passport, and therefore, does not input any data into the additional data prompt for passport data 387. Upon navigating to the third page 384, it triggers checkpoint 392 and the received application data is determined to still have missing identification data. The data prompt decision subsystem identifies another form of acceptable identification, such as a state-issued identification card, and creates an additional data prompt to collect the state-issued identification information 388 from the applicant. All the while, the product application service and the data prompt decision subsystem continue processing identity checks and other verification checks in parallel.

In some examples and features of the instant solution, the augmentation of the product application form 312 may include at least one additional data prompt being displayed with an option in an area approximate to the application form to communicate with an entity for assistance. For example, the at least one additional data prompt may include a link, a button, a verbal prompt, or the like, as an option for the applicant to contact an entity for assistance with the application form. The option may also allow the applicant to specify an entity type, such as a contact center agent, an operator, or an AI assistant/chatbot, to assist. When this option is selected from the application form 312, the option may be conveyed via the API or the UI to the product application service 340 (sec, for example, FIG. 3A), and the product application service may initiate a communication session to connect the requested entity with the applicant, where the communication session may be a textual chat session, an audio call, or a video call, and where the requested entity may be a contact center agent, an operator, or an AI assistant/chatbot. During the communication session with the requested entity, the product application service may disable the remaining data prompts on the application form, such as visually changing the color of the remaining application data prompts to a gray text and preventing the input fields from accepting data until the additional application data associated with the additional data prompt has been collected and the needed identity check has been satisfied. When this occurs, the remaining data prompts on the application form are reenabled, allowing the remaining application data to be collected for verification checks.

In some examples and features of the instant solution, the requested AI assistant/chatbot entity may utilize one or more additional AI models, such as an AI model (not shown) deployed to the AI production system 230 (see, for example, FIGS. 2A-2C, 3A) or deployed to another AI production system (not shown) and trained to assist with the prompts and data presented on the product application form. The AI assistant/chatbot may be visually represented as an avatar on the user interface of the product application form 312 or the software app 310 and may be configured to accept verbal input or typed input from the applicant and to reply with audible output or text output.

In some examples and features of the instant solution, the augmentation of the product application form 312 may include at least one additional data prompt being displayed as an overlay on the application form by the requested entity. For example, during the communication session with the requested entity, the entity may further prompt the applicant to provide relevant data for the at least one additional data prompt. Whether the entity's prompt is spoken or displayed as text, the product application service converts the entity's prompt and invokes the API or the UI to display the prompt and a corresponding input field as an overlay on the application form. The prompt and corresponding input field may accept typed input, or it may accept verbal input via the computing device's microphone, which then is converted into a format that the product application service can supply to the identity check.

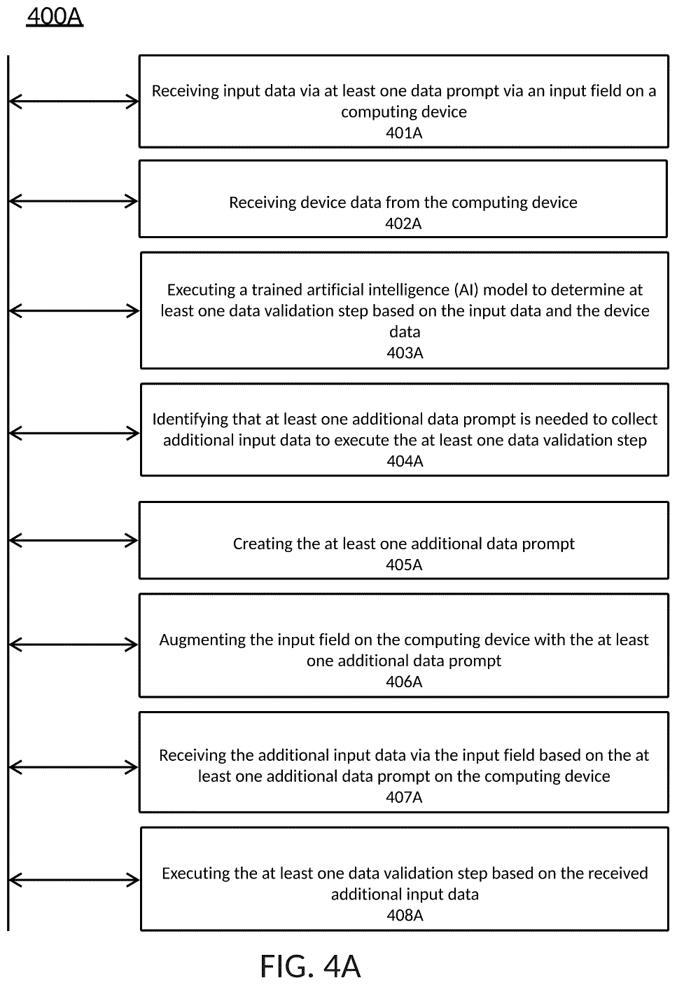

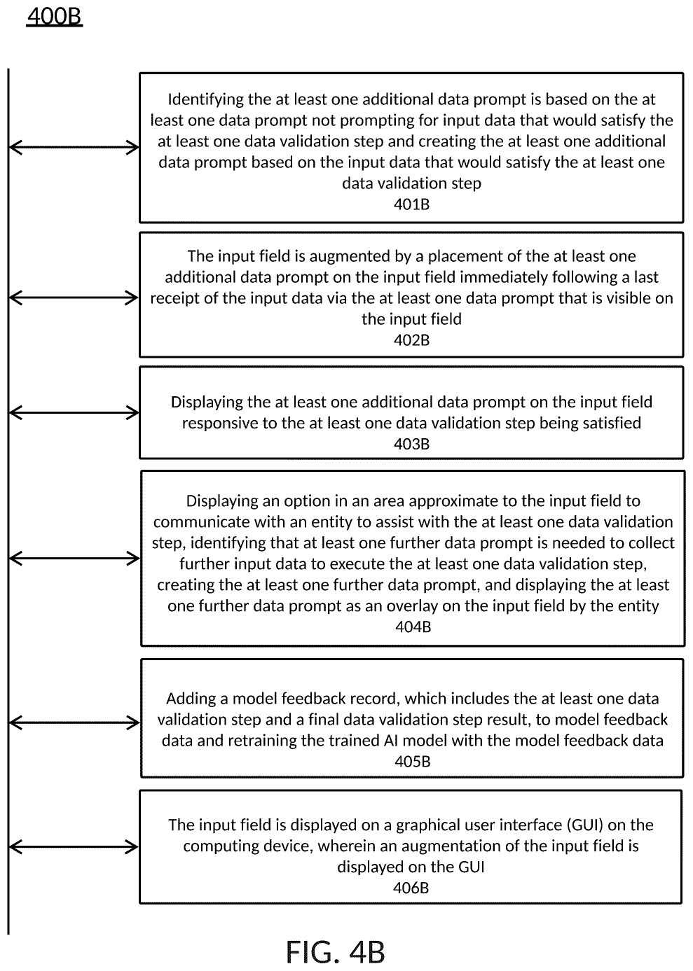

FIG. 4A illustrates an example of a method 400A for a product application service that identifies and creates at least one additional prompt to collect additional input data when processing at least one data validation step for an input field, according to examples and features of the instant solution. As an example, the method 400A may be performed by a computing system, a software application, a server, a cloud platform, a combination of systems, and the like. Referring to FIG. 4A, in 401A, the method may include receiving input data via at least one data prompt via an input field on a computing device. In 402A, the method may include receiving device data from the computing device. In 403A, the method may include executing a trained artificial intelligence (AI) model to determine at least one data validation step based on the input data and the device data. In 404A, the method may include identifying that at least one additional data prompt is needed to collect additional input data to execute the at least one data validation step. In 405A, the method may include creating the at least one additional data prompt. In 406A, the method may include augmenting the input field on the computing device with the at least one additional data prompt. In 407A, the method may include receiving the additional input data via the input field based on the at least one additional data prompt on the computing device. In 408A, the method may include executing the at least one data validation step based on the received additional input data.

FIG. 4B illustrates another method 400B for a product application service that identifies and creates at least one additional prompt to collect additional input data when processing at least one data validation step for an input field, according to examples and features of the instant solution. As an example, the method 400B may be performed by a computing system, a software application, a server, a cloud platform, a combination of systems, and the like. Referring to FIG. 4B, in 401B, the method may include identifying the at least one additional data prompt is based on the at least one data prompt not prompting for input data that would satisfy the at least one data validation step and creating the at least one additional data prompt based on the input data that would satisfy the at least one data validation step. In 402B, the method may include the input field is augmented by a placement of the at least one additional data prompt on the input field immediately following a last receipt of the input data via the at least one data prompt that is visible on the input field. In 403B, the method may include displaying the at least one additional data prompt on the input field responsive to the at least one data validation step being satisfied. In 404B, the method may include displaying an option in an arca approximate to the input field to communicate with an entity to assist with the at least one data validation step, identifying that at least one further data prompt is needed to collect further input data to execute the at least one data validation step, creating the at least one further data prompt, and displaying the at least one further data prompt as an overlay on the input field by the entity. In 405B, the method may include adding a model feedback record, which includes the at least one data validation step and a final data validation step result, to model feedback data and retraining the trained AI model with the model feedback data. In 406B, the method may include the input field is displayed on a graphical user interface (GUI) on the computing device, wherein an augmentation of the input field is displayed on the GUI.

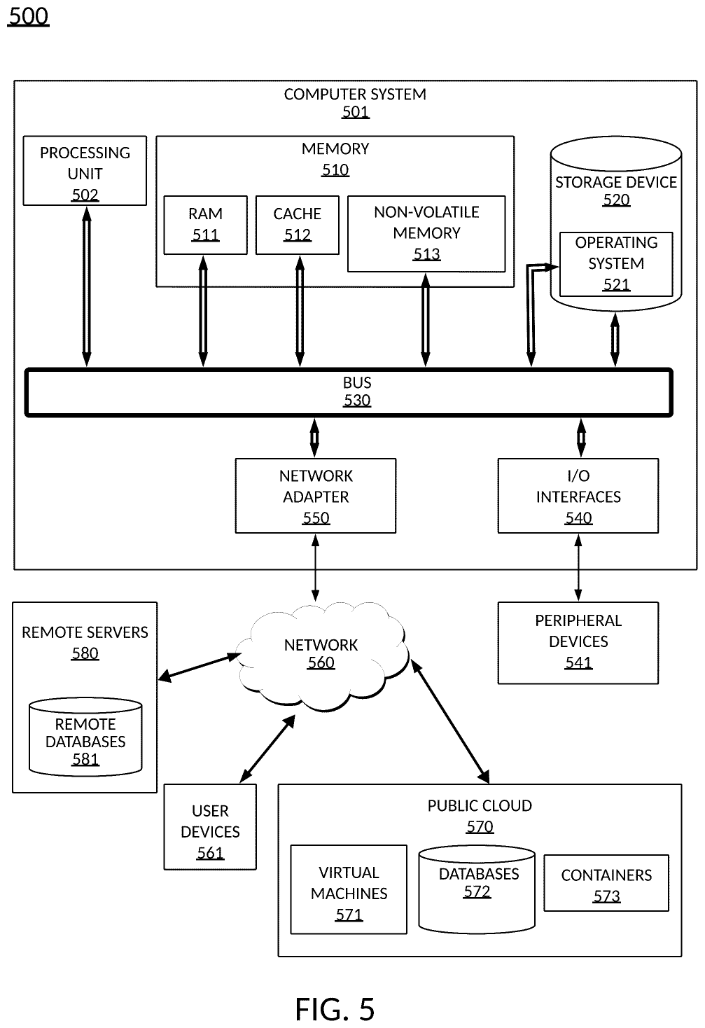

The examples and features of the instant solution may be implemented in one or more of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing devices. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus comprising:
a processor; and
a memory, wherein the processor and the memory are communicatively coupled, wherein the processor is configured to:
receive input data via at least one data prompt via an input field on a computing device;
receive device data from the computing device;
execute a trained artificial intelligence (AI) model to determine at least one data validation step based on the input data and the device data;
identify that at least one additional data prompt is needed to collect additional input data to execute the at least one data validation step;
create the at least one additional data prompt;
augment the input field on the computing device with the at least one additional data prompt;
receive the additional input data via the input field based on the at least one additional data prompt on the computing device; and
execute the at least one data validation step based on the received additional input data.

2. The apparatus of claim 1, wherein the at least one additional data prompt is:
identified based on the at least one data prompt not prompting for input data that would satisfy the at least one data validation step; and
created based on the input data that would satisfy the at least one data validation step.

3. The apparatus of claim 1, wherein the input field is augmented by a placement of the at least one additional data prompt on the input field immediately following a last receipt of the input data via the at least one data prompt that is visible on the input field.

4. The apparatus of claim 1, wherein the processor is configured to display the at least one additional data prompt on the input field responsive to the at least one data validation step being satisfied.

5. The apparatus of claim 1, wherein the processor is configured to:
display an option in an arca approximate to the input field to communicate with an entity to assist with the at least one data validation step;
identify that at least one further data prompt is needed to collect further input data to execute the at least one data validation step;
create the at least one further data prompt; and
display the at least one further data prompt as an overlay on the input field by the entity.

6. The apparatus of claim 1, wherein the processor is configured to:
add a model feedback record, which includes the at least one data validation step and a final data validation step result, to model feedback data; and
retrain the trained AI model with the model feedback data.

7. The apparatus of claim 1, wherein the input field is displayed on a graphical user interface (GUI) on the computing device, wherein an augmentation of the input field is displayed on the GUI.

8. A method comprising:
receiving input data via at least one data prompt via an input field on a computing device;
receiving device data from the computing device;
executing a trained artificial intelligence (AI) model to determine at least one data validation step based on the input data and the device data;
identifying that at least one additional data prompt is needed to collect additional input data to execute the at least one data validation step;
creating the at least one additional data prompt;
augmenting the input field on the computing device with the at least one additional data prompt;
receiving the additional input data via the input field based on the at least one additional data prompt on the computing device; and
executing the at least one data validation step based on the received additional input data.

9. The method of claim 8, comprising:
identifying the at least one additional data prompt is based on the at least one data prompt not prompting for input data that would satisfy the at least one data validation step; and
creating the at least one additional data prompt based on the input data that would satisfy the at least one data validation step.

10. The method of claim 8, wherein the input field is augmented by a placement of the at least one additional data prompt on the input field immediately following a last receipt of the input data via the at least one data prompt that is visible on the input field.

11. The method of claim 8, comprising displaying the at least one additional data prompt on the input field responsive to the at least one data validation step being satisfied.

12. The method of claim 8, comprising:
displaying an option in an area approximate to the input field to communicate with an entity to assist with the at least one data validation step;
identifying that at least one further data prompt is needed to collect further input data to execute the at least one data validation step;
creating the at least one further data prompt; and
displaying the at least one further data prompt as an overlay on the input field by the entity.

13. The method of claim 8, comprising:
adding a model feedback record, which includes the at least one data validation step and a final data validation step result, to model feedback data; and
retraining the trained AI model with the model feedback data.

14. The method of claim 8, wherein the input field is displayed on a graphical user interface (GUI) on the computing device, wherein an augmentation of the input field is displayed on the GUI.

15. A computer-readable storage medium comprising instructions stored therein which when executed by a processor cause the processor to perform:
receiving input data via at least one data prompt via an input field on a computing device;
receiving device data from the computing device;
executing a trained artificial intelligence (AI) model to determine at least one data validation step based on the input data and the device data;
identifying that at least one additional data prompt is needed to collect additional input data to execute the at least one data validation step;
creating the at least one additional data prompt;
augmenting the input field on the computing device with the at least one additional data prompt;
receiving the additional input data via the input field based on the at least one additional data prompt on the computing device; and
executing the at least one data validation step based on the received additional input data.

16. The computer-readable storage medium of claim 15, wherein the processor is configured to perform:
identifying the at least one additional data prompt is based on the at least one data prompt not prompting for input data that would satisfy the at least one data validation step; and
creating the at least one additional data prompt based on the input data that would satisfy the at least one data validation step

17. The computer-readable storage medium of claim 15, wherein the input field is augmented by a placement of the at least one additional data prompt on the input field immediately following a last receipt of the input data via the at least one data prompt that is visible on the input field.

18. The computer-readable storage medium of claim 15, wherein the processor is configured to display the at least one additional data prompt on the input field responsive to the at least one data validation step being satisfied.

19. The computer-readable storage medium of claim 15, wherein the processor is configured to perform:
displaying an option in an area approximate to the input field to communicate with an entity to assist with the at least one data validation step;
identifying that at least one further data prompt is needed to collect further input data to execute the at least one data validation step;
creating the at least one further data prompt; and
displaying the at least one further data prompt as an overlay on the input field by the entity.

20. The computer-readable storage medium of claim 15, wherein the processor is configured to perform:
adding a model feedback record, which includes the at least one data validation step and a final data validation step result, to model feedback data; and
retraining the trained AI model with the model feedback data.
